(19) United States
(12) Patent Application Publication
(10) Pub. No.: US 2012/0047745 A1
(43) Pub. Date: Mar. 1, 2012

(54) Garden Scissor Having an Auxiliary Blade

(76) Inventor: Chin-Sung Wu, Lu Kang Town (TW)

(21) Appl. No.: 12/909,965

(22) Filed: Oct. 22, 2010

(30) Foreign Application Priority Data
Sep. 1, 2010 (TW) 099129400

(51) Int. Cl. B26B 11/00

(52) U.S. Cl. 30/146

(57) ABSTRACT

A garden scissor having an auxiliary blade contains a first handle and a second handle, both of which are axially connected together, and a holder and a cutting blade, characterized in that: the holder includes a receiving groove mounted thereon and an auxiliary blade movably received in the receiving groove to be axially connected with the holder so that the auxiliary blade rotates axially to be moved outward based on requirement, thereby the garden scissor is portable and used easily to enhance operation value, and the griping method is not changed after rotating the auxiliary blade outward to cut the object, thus operating comfortably and conveniently.

### BACKGROUND OF THE INVENTION

1. Field of the Invention

The present invention relates to a garden tool, and more particularly to a garden scissor having an auxiliary blade to cut and trim a plant.

2. Description of the Prior Art

A conventional garden tool is only used to cut vegetables, fruits, flowers, and trees, but as desiring to trim the flowers, trees, or branches, the user has to apply another garden tool to trim the flowers and trees, carrying different-function garden tools inconveniently and changing the tools time-consumingly based on different requirement.

The present invention has arisen to mitigate and/or obviate the afore-described disadvantages.

### SUMMARY OF THE INVENTION

The primary object of the present invention is to provide a garden scissor having an auxiliary blade that the holder or the first cutting blade includes the auxiliary blade, and the auxiliary blade is stored in the receiving grooves to prevent from cutting a user. Also, the auxiliary blade is movably rotated to cut the object, thus being portable and used easily to enhance operation value.

Another object of the present invention is to provide a garden scissor having an auxiliary blade that the holder or the first cutting blade includes the auxiliary blade to be movably rotated and located at the certain position in the same direction as the holder and the first and the second cutting blades so that the griping method is not changed after rotating the auxiliary blade outward to cut and trim a plant, thus operating comfortably and conveniently.

To obtain the above objectives, a garden scissor having an auxiliary blade provided by the present invention contains:

a first handle and a second handle, both of which are axially connected together, the first handle includes a first gripping portion, a holder and a slot disposed on one end thereof away from the first gripping portion, the second handle includes a second gripping portion and a cutting blade axially connected on one end thereof away from the second gripping portion and axially inserted in the slot of the first handle so that the holder and the cutting blade cooperate with each other, and the cutting blade and the holder are operated by the first handle and the second handle to cut an object.

### BRIEF DESCRIPTION OF THE DRAWINGS

FIG. 1 is a perspective view showing the exploded components of a garden scissor having an auxiliary blade according to a first embodiment of the present invention;

FIG. 2 is a perspective view showing the assembly of the garden scissor having the auxiliary blade according to the first embodiment of the present invention;

FIG. 3 is a partial cross sectional view showing the assembly of the garden scissor having the auxiliary blade according to the first embodiment of the present invention;

FIG. 4 is a partial cross sectional view showing the auxiliary blade of the garden scissor being rotated outward according to the first embodiment of the present invention;

FIG. 5 is a plan view showing the operation of the garden scissor having the auxiliary blade according to the first embodiment of the present invention;

FIG. 6 is a perspective view showing the auxiliary blade of the garden scissor being rotated outward according to a second embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

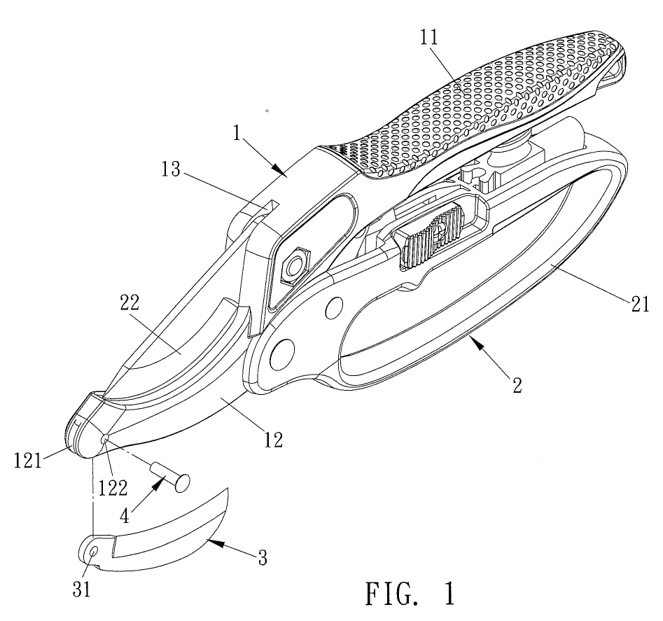

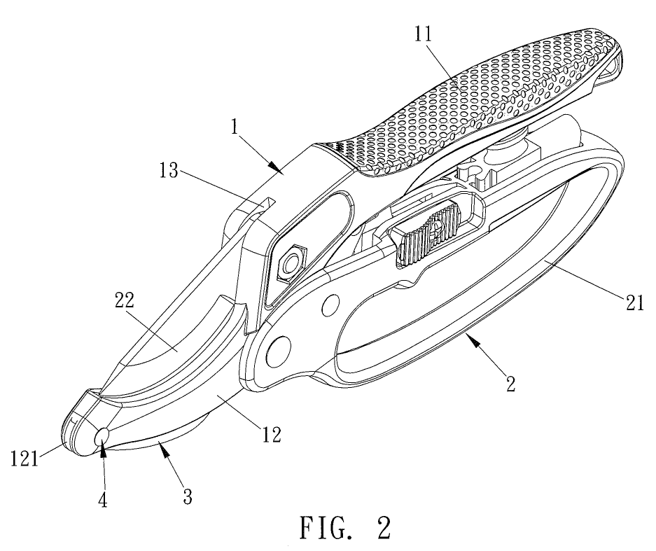

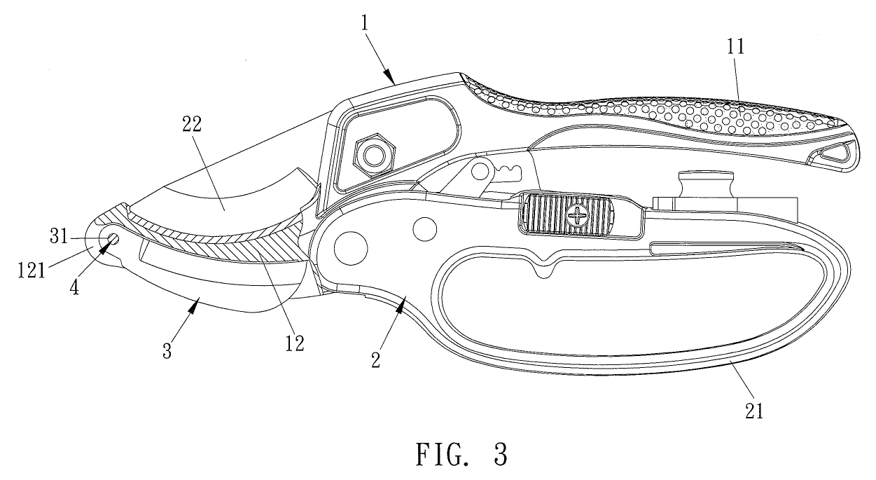

With reference to FIGS. 1-3, a garden scissor having an auxiliary blade according to a first embodiment of the present invention comprises a first handle 1 and a second handle 2, both of which are axially connected together, the first handle 1 includes a first gripping portion 11, a holder 12 and a slot 13 disposed on one end thereof away from the first gripping portion 11, the second handle 2 includes a second gripping portion 21 and a cutting blade 22 axially connected on one end thereof away from the second gripping portion 21 and axially inserted in the slot 13 of the first handle 1 so that the holder 12 and the cutting blade 22 cooperate with each other, and the cutting blade 22 and the holder 12 are operated by the first handle 1 and the second handle 2 to cut an object.

The holder 12 includes a receiving groove 121 mounted on an outer surface thereof and an auxiliary blade 3 movably received in the receiving groove 121, includes an axial hole 122 fixed on a front end thereof and communicating with the receiving groove 121, and the auxiliary blade 3 includes a bore 31 arranged on one end thereof to insert a coupling shaft 4 which is also inserted into the axial hole 122 so that the holder 12 and the auxiliary blade 3 are axially coupled together, hence the auxiliary blade 3 is axially rotated to be stored in the receiving groove 121 of the holder 12 by using the coupling shaft 4, and one part of a back side of the auxiliary blade 3 extends out of the receiving groove 121 so that the auxiliary blade 3 rotates axially to be moved outward.

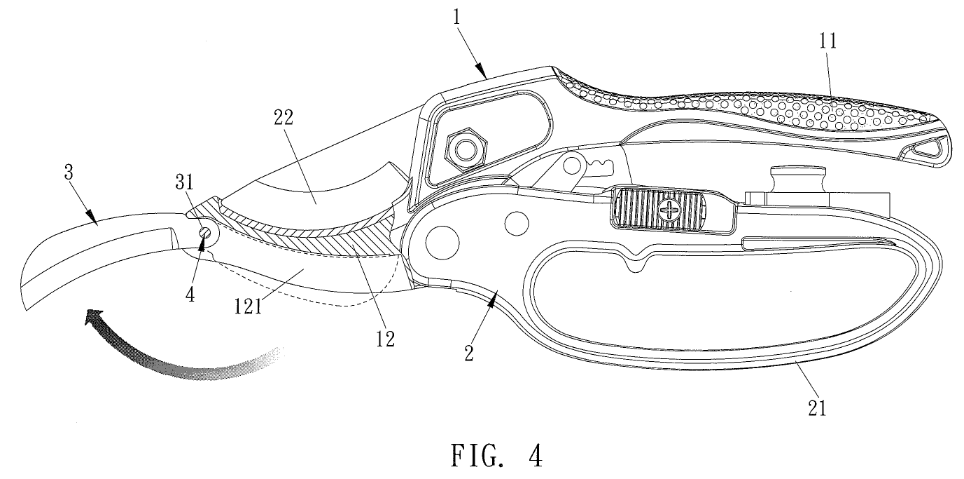

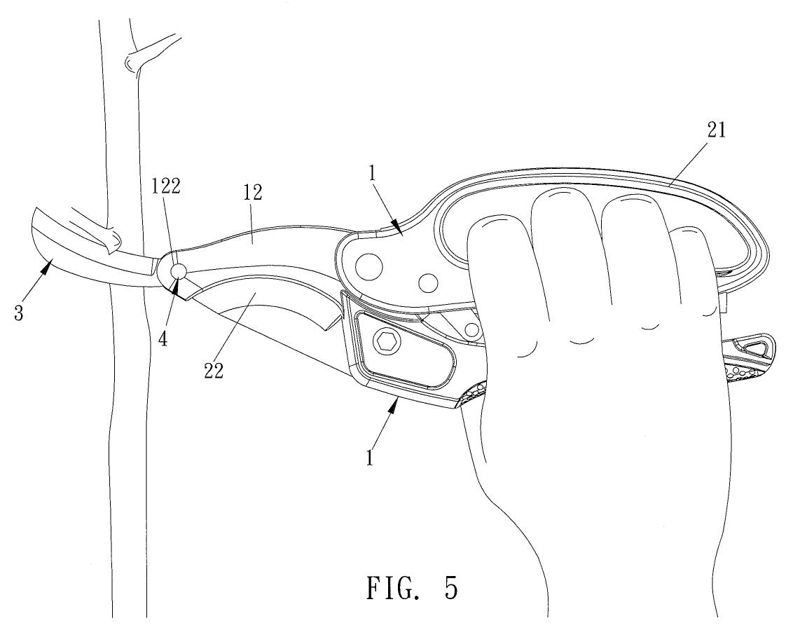

When the auxiliary blade 3 is applied to cut flowers, trees, and branches as shown in FIGS. 4 and 5, the auxiliary blade 3 is rotated outward along the coupling shaft 4, and because the auxiliary blade 3 is located at a certain position in the same direction as the holder 12 and the cutting blade 22, a griping method is not changed to grip the first and the second gripping portions 1, 2 so as to cut the object by ways of the auxiliary blade 3.

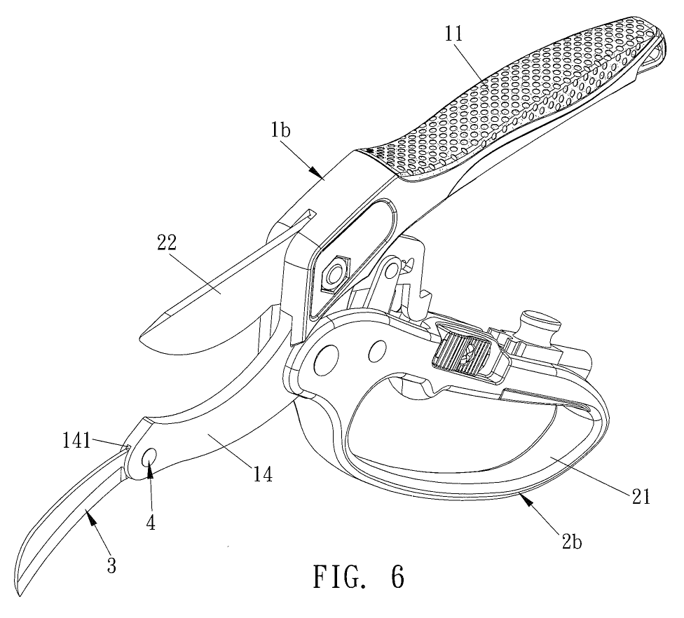

With reference to FIG. 6, a garden scissor having an auxiliary blade according to a second embodiment of the present invention comprises a first handle 1a and a second handle 2a, both of which are axially connected together, the first handle 1a includes the first gripping portion 11 and a first cutting blade 14 disposed on one end thereof away from the first gripping portion 11, the second handle 2a includes the second gripping portion 21 and a second cutting blade 22 away from the second gripping portion 21 so that the first cutting blade 14 and the second cutting blade 22 cooperate with each other, and the first and the second cutting blades 14, 22 are operated by the first handle 1a and the second handle 2a to cut an object.

The first cutting blade 14 includes a receiving groove 141 mounted on an outer surface thereof and the auxiliary blade 3 movably received in the receiving groove 141 which is fixed on a front end of the first cutting blade 14, includes an axial hole fixed on a front end thereof and communicating with the receiving groove 141, and the auxiliary blade 3 includes a bore 31 arranged on one end thereof to insert a coupling shaft 4 which is also inserted into the axial hole so that the auxiliary blade 3 is axially rotated to be stored in the receiving groove 141 of the first cutting blade 14 by using the coupling shaft 4, and one part of a back side of the auxiliary blade 3 extends out of the receiving groove 141 so that the auxiliary blade 3 rotates axially to be moved outward.

Thereby, the garden scissor having the auxiliary blade of the present invention has the following advantages:

1. The holder 12 or the first cutting blade 14 includes the auxiliary blade 3, and the auxiliary blade 3 is stored in the receiving grooves 121, 141 to prevent from cutting a user. Also, the auxiliary blade 3 is movably rotated to cut the object, thus being portable and used easily to enhance operation value.

2. The holder 12 or the first cutting blade 14 includes the auxiliary blade 3 to be movably rotated and located at the certain position in the same direction as the holder 12 and the first and the second cutting blades 22 so that the griping method is not changed after rotating the auxiliary blade 3 outward to cut the object, thus operating comfortably and conveniently.

While we have shown and described various embodiments in accordance with the present invention, it is clear to those skilled in the art that further embodiments may be made without departing from the scope of the present invention.

What is claimed is:

1. A garden scissor having an auxiliary blade comprising:
a first handle and a second handle, both of which are axially connected together, and a holder and a cutting blade, characterized in that:
the holder includes a receiving groove mounted thereon and an auxiliary blade movably received in the receiving groove to be axially connected with the holder so that the auxiliary blade rotates axially to be moved outward based on requirement.

2. The garden scissor having the auxiliary blade as claimed in claim 1, wherein the receiving groove is mounted on an outer surface of the holder, and the holder includes an axial hole fixed on a front end thereof and communicating with the receiving groove so that the axial hole matches with a coupling shaft to axially connect with the auxiliary blade, and the auxiliary blade is movably rotated.

3. The garden scissor having the auxiliary blade as claimed in claim 2, wherein the auxiliary blade includes a bore arranged on one end thereof to insert the coupling shaft which is also inserted into the axial hole.

4. A garden scissor having an auxiliary blade comprising:
a first handle and a second handle, both of which are axially connected together, and a first cutting blade and a second cutting blade, both of which are cooperated with each other, characterized in that:
the first cutting blade includes a receiving groove mounted thereon and an auxiliary blade movably received in the receiving groove to be axially connected with the first cutting blade so that the auxiliary blade rotates axially to be moved outward based on requirement.

5. The garden scissor having the auxiliary blade as claimed in claim 4, wherein the receiving groove is mounted on an outer surface of the first cutting blade, and the first cutting blade includes an axial hole fixed on a front end thereof and communicating with the receiving groove so that the axial hole matches with a coupling shaft to axially connect with the auxiliary blade, and the auxiliary blade is movably rotated.

6. The garden scissor having the auxiliary blade as claimed in claim 5, wherein the auxiliary blade includes a bore arranged on one end thereof to insert the coupling shaft which is also inserted into the axial hole.
